(19) United States
(12) Patent Application Publication
(10) Pub. No.: US 2023/0153689 A1
(43) Pub. Date: May 18, 2023

(54) INFORMATION PROCESSING METHOD AND ELECTRONIC DEVICE

(71) Applicant: NEC CORPORATION, Tokyo (JP)

(72) Inventors: Erli WANG, Beijing (CN); Lu FENG, Beijing (CN)

(73) Assignee: NEC CORPORATION, Tokyo (JP)

(21) Appl. No.: 17/988,409

(22) Filed: Nov. 16, 2022

(30) Foreign Application Priority Data
Nov. 16, 2021 (CN) 202111369743.2

(51) Int. Cl. G06N 20/00

(52) U.S. Cl. CPC G06N 20/00

(57) ABSTRACT

Embodiments of the present disclosure relate to an information processing method and an electronic device and relate to a computer field. The method comprises: obtaining input information from a user, the input information at least indicating at least one of: attribute information of at least one target object, or information of a current perception category of the at least one target object; determining a target decision for the at least one target object based on the input information using a trained decision model; and outputting the target decision. In this way, the embodiments of the present disclosure can output a target decision corresponding to the input information of the user based on the trained decision model, so as to provide a reference to the user for decision making and facilitate the user to maintain the perception category of the target object.

### CROSS-REFERENCES TO RELATED APPLICATIONS

This application claims priority to CN Application No. 202111369743.2, entitled automatically and efficiently INFORMATION PROCESSING METHOD AND ELECTRONIC DEVICE, and filed on Nov. 16, 2021, the entire contents of that application being incorporated herein by reference in its entirety.

### FIELD

Embodiments of the present disclosure generally relate to a field of computers, and more specifically, to an information processing method, a model training method, an electronic device, a computer-readable storage medium, and a computer program product.

### BACKGROUND

Customer experience (CX) is the internal and subjective response customers have to any direct or indirect contact with a company. CX is influenced by various factors, such as quality of product/service, packaging, advertising, ease of use, and reliability, etc. CX may be characterized by customer satisfaction, loyalty, and word of mouth, etc.

Existing satisfaction surveys generally come in the form of questionnaires, which are time-consuming and laborious; and it frequently occurs that customers are reluctant to react to the questionnaires. In addition, such questionnaires can only evaluate the customers' immediate satisfaction, unable to effectively offer a corresponding strategy for maintaining or enhancing satisfaction.

### SUMMARY

Exemplary embodiments of the present disclosure provide a solution for information processing, which can offer a user a target decision for a target object.

According to a first aspect of the present disclosure, there is provided an information processing method, comprising: obtaining input information from a user, the input information at least indicating at least one of: attribute information of at least one target object, or information of a current perception category of the at least one target object; determining a target decision for the at least one target object based on the input information using a trained decision model; and outputting the target decision.

According to a second aspect of the present disclosure, there is provided a model training method, comprising: constructing a training set, the training set comprising a plurality of data items, each of the plurality of data items comprising: attribute information, a current perception category, a decision, a transitioned perception category for the attribute information from the current perception category after applying the decision, and corresponding reward information during transitioning from the current perception category to the transitioned perception category; and generating a decision model at least based on the training set.

According to a third aspect of the present disclosure, there is provided an electronic device, comprising: at least one processing unit; at least one memory, the at least one memory being coupled to the at least one processing unit and configured to store instructions for being executed by the at least one processing unit, the instructions, when executed by the at least one processing unit, cause the electronic device to perform actions comprising: obtaining input information from a user, the input information at least indicating at least one of: attribute information of at least one target object, or information of a current perception category of the at least one target object; determining a target decision for the at least one target object based on the input information using a trained decision model; and outputting the target decision.

According to a fourth aspect of the present disclosure, there is provided an electronic device, comprising: at least one processing unit; at least one memory, the at least one memory being coupled to the at least one processing unit and configured to store instructions for being executed by the at least one processing unit, the instructions, when executed by the at least one processing unit, cause the electronic device to perform actions comprising: constructing a training set, the training set comprising a plurality of data items, each of the plurality of data items comprising: attribute information, a current perception category, a decision, a transitioned perception category for the attribute information from the current perception category after applying the decision, and corresponding reward information during transitioning from the current perception category to the transitioned perception category; and generating a decision model at least based on the training set.

According to a fifth aspect of the present disclosure, there is provided an electronic device, comprising: a memory and a processor; wherein the memory is configured to store one or more computer instructions, wherein the one or more computer instructions are executed by the processor to perform the method described according to the first or second aspect of the present disclosure.

According to a sixth aspect of the present disclosure, there is provided a computer readable storage medium, the computer readable storage medium having a machine-executable instruction stored thereon, the machine-executable instruction, when being executed by a device, causes the device to perform the method described according to the first or second aspect of the present disclosure.

According to a seventh aspect of the present disclosure, there is provided a computer program product, comprising a computer-executable instruction, wherein the computer-executable instruction, when being executed by the processor, implements the method described according to the first or second aspect of the present disclosure.

According to an eighth aspect of the present disclosure, there is provided an electronic device, comprising: a processing circuit apparatus configured to perform the method described according to the first or second aspect of the present disclosure.

The Summary is to introduce a series of concepts in a simplified form which will be further described in the Detailed Description. The Summary is not intended to identify key features or essential features of the present disclosure, nor is it intended to be used to limit the scope of the present disclosure. Other features of the present disclosure will be made apparent by the following depictions.

### BRIEF DESCRIPTION OF THE DRAWINGS

The above and other features, advantages and aspects of the present disclosure will become more apparent through the detailed description below with reference to the accompanying drawings. Throughout the drawings, like or similar reference numerals represent same or similar elements, wherein:

FIG. 1 illustrates a block diagram of an example environment according to embodiments of the present disclosure;

FIG. 2 illustrates a flowchart of an example training process according to embodiments of the present disclosure;

FIG. 3 illustrates a schematic diagram of an example causal graph according to embodiments of the present disclosure;

FIG. 4 illustrates a flowchart of an example use process according to embodiments of the present disclosure;

FIG. 5 illustrates a schematic diagram for determining a target group based on information of a number threshold according to embodiments of the present disclosure.

FIG. 6 illustrates a schematic diagram of a transition of perception categories according to embodiments of the present disclosure; and

FIG. 7 illustrates a block diagram of an example device according to embodiments of the present disclosure.

### DETAILED DESCRIPTION OF EMBODIMENTS

Hereinafter, embodiments of the present disclosure will be described in more detail with reference to the accompanying drawings. Although the drawings illustrate some exemplary implementations of the present disclosure, it is to be understood that the present disclosure can be implemented in various ways, and the illustrated embodiments should not be construed as being limited to the embodiments set forth herein. On the contrary, these embodiments are provided to enable a more thorough and complete understanding of the present disclosure. It is to be appreciated that the drawings and embodiments of the present disclosure are only used for exemplary purposes, and are not intended to limit the protection scope of the present disclosure.

As used herein, the term “includes” and its equivalents are to be read as open terms that mean “includes, but is not limited to.” The term “based on” is to be read as “based at least in part on.” The terms “one embodiment” or “the embodiment” is to be read as “at least one example embodiment.” The term “first,” “second,” and the like may refer to different or the same objects. Other definitions, either explicit or implicit, may be included below.

Various methods and processes described in the embodiments of the present disclosure may also be applied to various kinds of electronic devices, e.g., terminal devices, network devices, etc. The embodiments of the present disclosure may also be executed in a test device, such as a signal generator, a signal analyzer, a spectrum analyzer, a network analyzer, a test terminal device, a test network device, and a channel simulator, etc.

The term “circuitry” used herein may refer to hardware circuits and/or combinations of hardware circuits and software. For example, the circuitry may be a combination of analog and/or digital hardware circuits with software/firmware. As an alternative example, the circuitry may be any portions of hardware processors with software including digital signal processor(s), software, and memory(ies) that work together to cause an apparatus to perform various functions. In a still further example, the circuitry may be hardware circuits and or processors, such as a microprocessor or a portion of a microprocessor, that requires software/firmware for operation, but the software may not be present when it is not needed for operation. As used herein, the term “circuitry” also covers implementation of merely a hardware circuit or processor(s), or a fraction of a hardware circuit or processor(s) in conjunction with the software and/or firmware affixed thereto.

Nowadays, market competition becomes increasingly intense. In order to maintain a long-lasting competitive edge, one of the concerns for enterprises (such as network operators, banks, insurance companies, supermarkets, software providers, and SaaS providers) is to maintain and even improve customer experience.

In the business environment with intensifying competition, it is a belief among companies and scholars home and abroad that to create a long-lasting competitive value, an enterprise should be customer-oriented. The customer experience (CX) is associated with the quality of product/service, while a measurement of the quality of product/service involves metrics of multiple items including reliability, assurance, tangibility, empathy and responsiveness. CX may further involve a list of experience components, such as customer's senses, emotions, thoughts, acts, and values, etc. On the other hand, a customer experience system may be constructed based on factors such as customer satisfaction, loyalty, and word-of-mouth.

Take the customer satisfaction for example, which is essentially the culmination of a series of customer experiences. Real data analysis reveals that the responses from similar population to the same strategy inevitably have stochasticity due to subjectivity. In addition, if no effective strategies are provided to the customers within a period of time, the customer satisfaction tends to decrease gradually. Existing satisfaction analysis or prediction systems are only preliminarily software-driven and digitalized, but cannot realize effective improvement of decision-making information with the data information derived.

In view of the above, embodiments of the present disclosure provide a decision-making solution to solve one or more of the above and/or other potential problems. In the solution, a trained decision model may be utilized to determine a target decision. The target decision is applied to maintain or improve user experience.

Hereinafter, various embodiments of the present disclosure will be described in detail in an example scene of a field of operator services. It is understood that the embodiments described herein are only for illustrative purposes, not intended to limit the scope of the present disclosure in any way.

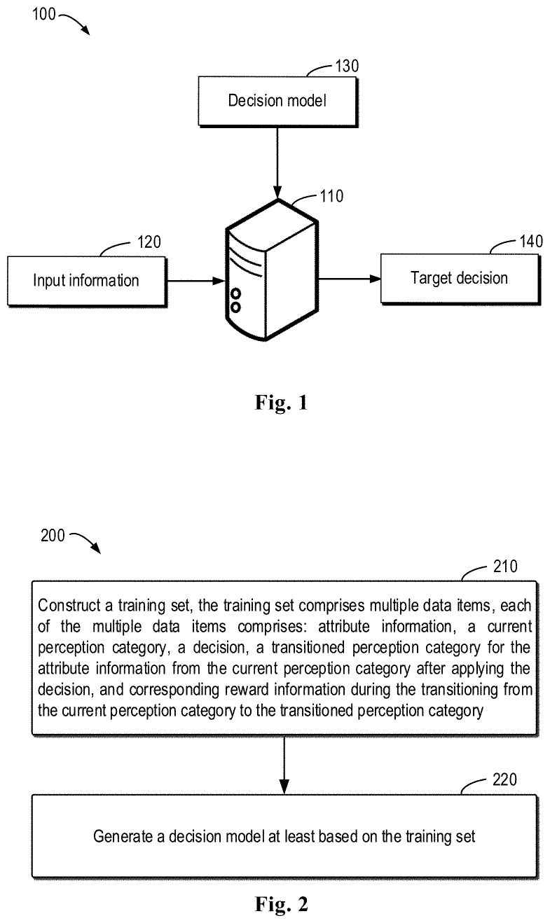

FIG. 1 illustrates a block diagram of an example environment 100 according to embodiments of the present disclosure. The environment 100 illustrated in FIG. 1 is only an example in which some embodiments of the present disclosure can be implemented, not intended for limiting the scope of the present disclosure. The embodiments of the present disclosure are also suitable for other systems or architectures.

As illustrated in FIG. 1, the environment 100 may comprise a computing device 110. The computing device 110 may be any device with computing capabilities. The computing device 110 may include, but is not limited to, a personal computer, a server computer, a portable or laptop device, a mobile device (e.g., a mobile phone, a personal digital assistant PDA, a media player, etc.), a wearable device, a consumer electronic product, a mini computer, a main frame, a distributed computing system, and a cloud computing resource, etc. It is understood that based on considerations of factors such as costs, the computing device 110 may have or do not have sufficient computing resources for model training.

The computing device 110 may be configured to receive input information 120 from a user and output a target decision 140. Determination of the target decision 140 may be implemented by a trained decision model 130.

It is noted that a user in the embodiments of the present disclosure may refer to a product/service provider of an enterprise, a bank, an operator or the like, or may refer to an operator (e.g., an administrator) of such providers, or may refer to a third party independent of such providers, or may refer to an operator of the third party. A customer in the embodiments of the present disclosure may comprise an object of the product or service provided by such providers, e.g., a consumer, or a user of the product or service.

The input information 120 may be information inputted by the user and related to a target object. The input information 120 may indicate attribute information and a current perception category of the target object. It is noted that the embodiments of the present disclosure have no limitations to specific forms of the input information. For example, the input information may include at least one of: a name, an identifier (e.g., an ID number, a mobile phone number, a bank card number, and an associated membership number, etc.), attribute information, or a current perception category of the target object.

The attribute information may represent the identity or the like of the target object, e.g., age, gender, job, residence, etc. The attribute information generally refers to information which cannot be modified by the user. The current perception category may belong to a set of perception categories which may include multiple perception categories. As an example, the current perception category is {highSat, lowLoy}. Descriptions of the attribute information and the set of perception categories may refer to the embodiment with reference to FIG. 2.

The target decision 140 may belong to a set of decisions. The set of decisions may include one or more decisions. Each decision may include one or more actions. In the embodiments of the present disclosure, the “action” may represent providing a specific service or information to the customer. For example, in the field of operator services, the target decision 140 may include one action, e.g., “offer 20 GB data package at a price of RMB 10,” and correspondingly, the target decision 140 may be represented as {offer 20 GB data package at a price of RMB 10}. For example, in the field of mall services, the target decision 140 may include two actions, one action is “offer a 20%-off gift card” and the other action is “offer a voucher of RMB 30”; correspondingly, the target decision 140 may be represented as {offer a 20%-off gift card and a voucher of RMB 30}. Note that the embodiments of the present disclosure have no limitation to the specific manner of providing a specific service or information to the customer, e.g., sending an instruction or information to the customer's terminal device via a customer service system. Description of the set of decisions may refer to the embodiment with reference to FIG. 2.

In some embodiments, the decision model 130 may be trained prior to carrying out the above process. It is understood that the decision model 130 may be trained by the computing device 110 or any other appropriate device external to the computing device 110. The trained decision model 130 may be deployed in the computing device 110 or may be deployed external to the computing device 110. Hereinafter, an example training process may be described with reference to FIG. 2, where the decision model 130 is trained by the computing device 110.

FIG. 2 illustrates a flowchart of an example training process 200 according to embodiments of the present disclosure. For example, the method 200 may be performed by the computing device 110 as shown in FIG. 1. It is understood that the method 200 may further comprise an additional block(s) which is(are) not illustrated and/or may omit some of the illustrated blocks. The scope of the present disclosure is not limited in this aspect.

At block 210, a training set is constructed, the training set comprises multiple data items, each of the multiple data items comprises: attribute information, a current perception category, a decision, a transitioned perception category for the attribute information from the current perception category after applying the decision, and corresponding reward information during the transitioning from the current perception category to the transitioned perception category.

At block 220, a decision model is generated at least based on the training set.

The decision model 130 may comprise a set of perception categories, a set of decisions, a transition function, and a reward function. The set of perception categories may comprise multiple perception categories, and the set of decisions may comprise multiple decisions. The transition function may represent a probability of perception category transition incurred from applying the decision. The reward function is used for representing a reward obtained by applying the decision.

In some embodiments of the present disclosure, the set of perception categories and the set of decisions may be predetermined. The set of perception categories may comprise multiple perception categories, and the set of decisions may comprise multiple decisions.

Exemplarily, the user (such as an operator, bank, etc.) may determine a set of perception categories based on customer experience indexes of interest. For example, supposing that the customer experience indexes of interest include satisfaction and loyalty, then the perception category may be defined to include {highSat, highLoy}, {highSat, lowLoy}, {lowSat, highLoy}, {lowSat, lowLoy}, and {leave}, which may be represented as s₁ to s₅, respectively, as illustrated in Table 1.

TABLE 1

| | Perception Category |
|---|---|
| s₁ | {highSat, highLoy} |
| s₂ | {highSat, lowLoy} |
| s₃ | {lowSat, highLoy} |
| s₄ | {lowSat, lowLoy} |
| s₅ | {leave} |

Exemplarily, the user (e.g., an operator, a bank) may determine a set of decisions based on the product and/or service provided. A granularity of the product and/or service that can be provided by the user is referred to as an atom action, such that the set of decisions may be determined based on a combination of atom actions. For example, supposing that the atom actions (or simply referred to as actions) that can be provided by the user include N actions, the set of decisions may be determined based on a combination of the N actions. In some examples, the number of the decisions included in the set of decisions may be equal to n^{th} power of 2, i.e., 2^{N}. In some other examples, the mutual exclusiveness between different actions may be taken into account, such that the number of the decisions included in the set of decisions is less than 2^{N}.

Take the field of operator services as an example, the action “offer a 4G package” and the action “offer a 5G package” may be mutually exclusive, thus there is no decision concurrently including “offer a 4G package” and “offer a 5G package”. Take the field of insurance services as an example, the action “offer an accident insurance of RMB 300,000” and the action “offer an accident insurance of RMB500,000” may be mutually exclusive, thus there is no decision concurrently including “offer an accident insurance of RMB 300,000” and “offer an accident insurance of RMB500,000”. It is understood that the above examples are only illustrative, and the user may set various kinds of mutually exclusive actions depending on actual needs, or even does not set any mutually exclusive actions.

In this way, by considering the relationships between different actions, the order of magnitude of the decisions may be significantly decreased, such that the subsequent training process can be facilitated, thereby improving processing efficiency.

In some embodiments of the present disclosure, a causal model may be leveraged to determine the set of perception categories and the set of decisions.

The causal model may be referred to as a satisfaction evaluation model or otherwise. The causal model may be determined manually, such as empirically. The causal model may also be derived using a causal discovery method by training the user's dataset. The embodiments of the present disclosure have no limitations in this aspect. Exemplarily, the causal discovery method may include, but is not limited to, the Peter-Clark Algorithm (PC), Greedy Equivalent Search (GES), Linear non-Gaussian Model (LinGAM), or Causal Additive Model (CAM), etc.

The causal model involves a causal graph comprising multiple nodes, where directed edges are present between the nodes. Multiple nodes include at least one target node, and none of the target nodes has an outputting directed edge. In other words, a directed edge directed to another node from the target node does not exist. All other nodes than the target node in the multiple nodes are referred to as cause nodes. That is to say, any cause node has a directed edge directed to another node.

Multiple nodes comprise at least one source node. Each source node only has an outputting directed edge. In other words, the source node does not have a directed edge directed from another node to the source node. A source node may represent a domain variable or a covariate, where the source node representing a domain variable does not have a directed edge directed to the target node, while the source node representing a covariate has a directed edge directed to the target node. The source node representing the domain variable may be referred to as a domain source node, and the source node representing the covariate may be referred to as a cooperative source node. Multiple nodes may comprise actable nodes, where each actable node may be modified or adjusted by the user (e.g., an enterprise). Exemplarily, a source node having both of a directed edge directed to the target node and a directed edge directed to the actable node may represent a background variable, which, for example, is referred to as a background source node.

In some examples, at least one target node may be determined from multiple nodes. Furthermore, the set of perception categories for the decision model may be determined based on the at least one target node. Specifically, at least one target node may be determined based on a customer experience index, where the customer experience index may include satisfaction, loyalty, or word of mouth, etc.

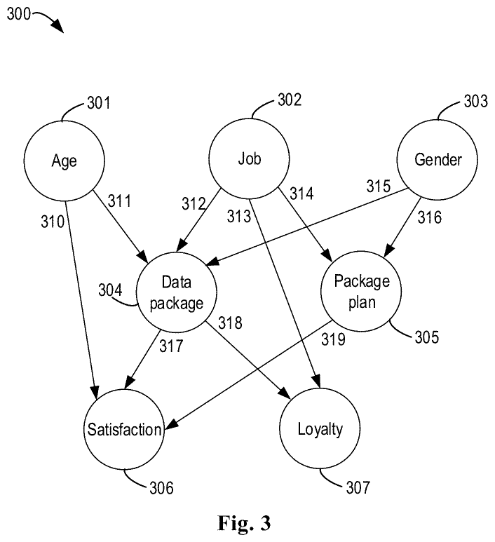

FIG. 3 illustrates a schematic diagram of a causal graph 300 involved in the causal model, which uses a field of operator services as an example.

The causal graph 300 comprises nodes 301 to 307 and directed edges 310 to 319.

Node 306 represents satisfaction, and node 307 represents loyalty. Node 306 and node 307 each does not have a directed edge directed to another node, i.e., none of the directed edges is originated from node 306 or node 307; therefore, node 306 and node 307 are determined as target nodes.

Node 301 represents age, node 302 represents job, and node 303 represents gender. None of the directed edges are directed to nodes 301 to 303; therefore, nodes 301 to 303 are source nodes. Since the directed edges 315 and 316 starting from node 303 are not directed to the target nodes, node 303 is a domain source node. Since the directed edge 310 starting from the node 301 is directed to the target node 306 and the directed edge 313 starting from the node 302 is directed to the target node 307, node 301 and node 302 are cooperative source nodes.

Since node 302 is a source node and the directed edges starting from node 302 not only include a directed edge (directed edge 313) directed to the target node but also include a directed edge (directed edges 312 and 314) directed to an actable node, the node 302 is a background source node.

Node 304 represents data package, and node 305 represents package plan. Since node 304 and node 305 may be modified or adjusted by the user (e.g., operator), node 304 and node 305 are actable nodes.

Referring to FIG. 3, all directed edges starting from the domain source node are directed to the actable nodes, e.g., directed edge 315 is directed from node 303 to node 304, and directed edge 316 is directed from node 303 to node 305. The directed edges starting from the cooperative source nodes include directed edges directed to the actable nodes and directed edges directed to the target nodes, e.g., directed edge 310 is directed from node 301 to node 306, and directed edge 311 is directed from node 301 to node 304.

It is understood that the causal graph 300 illustrated in FIG. 3 is only illustrative. For example, a source node may also represent educational degree, residence, or income level, etc.; for example, an actable node may be set based on an actual service of the user (e.g., an operator); for example, a target node may also represent word of mouth, etc. The present disclosure has no limitations thereto.

It is understood that the causal graph may be determined by the user (e.g., an operator, a bank, etc.). For example, a source node of the causal graph may be determined based on attribute information of the customer; an actable node may be determined based on a product or service provided by the user; and a target node may be determined based on a customer experience index of interest. The present disclosure has no limitations thereto.

As an example, suppose the attribute information includes age, job, and gender, which may be represented as x₁ to x₃, respectively, as shown in Table 2.

TABLE 2

| | Attribute Information |
|---|---|
| x₁ | age |
| x₂ | job |
| x₃ | gender |

In some embodiments, the set of perception categories may be determined based on the target nodes. Alternatively, the set of perception categories may be referred to as a state set or a state space or otherwise, which is not limited herein.

As an example, node 306 in the causal graph 300 represents satisfaction, and node 307 represents loyalty. Suppose the satisfaction score is within a range [v₁₁, v₁₂], the loyalty score is within a range [v₂₁, v₂₂], where v₁₁<v₁₂ and v₂₁<v₂₂. It is noted that specific values of v₁₁, v₁₂, v₂₁ and v₂₂ are not limited in the embodiments of the present disclosure. In an example, v₁₁=v₂₁=1, v₁₂=v₂₂=10; however, those skilled in the art may appreciate that other values are also applicable, which will not be enumerated here.

Satisfaction may be classified into high satisfaction (highSat) and low satisfaction (lowSat). For example, [v₁₁, v₁₂] may be divided into a high score interval and a low score interval, where the high score interval corresponds to high satisfaction, and the low score interval corresponds to low satisfaction.

Similarly, loyalty may be classified into high loyalty (highLoy) and low loyalty (lowLoy). For example, [v₂₁, v₂₂] may be divided into a high score interval and a low score interval, where the high score interval corresponds to high loyalty, and the low score interval corresponds to low loyalty.

Furthermore, multiple perception categories may be determined, including: {highSat, highLoy}, {highSat, lowLoy}, {lowSat, highLoy}, {lowSat, lowLoy}, and {leave}, as illustrated in Table 1 above.

In some embodiments, the set of decisions may be determined based on actable nodes. Alternatively, the set of decisions may be referred to as a set of strategies or action space or otherwise, which is not limited herein.

As an example, node 304 in the causal graph 300 represents data package, and node 305 represents package plan. Suppose the actions (services) provided by the user (e.g., an operator) include: offer a 10 GB data package at a price of RMB 20, offer a 50 GB data package at a price of RMB 50, and offer a 5G package upgrade.

Furthermore, multiple decisions may be determined, including: {do nothing}, {offer a 10 GB data package at a price of RMB 20}, {offer a 50 GB data package at a price of RMB 50}, {offer 5G package upgrade}, {offer a 10 GB data package at a price of RMB 20 and 50 GB data package at a price of RMB 50}, {offer a 50 GB data package at a price of RMB 50 and 5G package upgrade}, {offer a 10 GB data package at a price of RMB 20 and 5G package upgrade}, and {offer a 10 GB data package at a price of RMB 20, 50 GB data package at a price of RMB 50, and 5G package upgrade}. In other words, the set of decisions may include 8 elements, which may be exemplarily represented as a₁ to a₈, respectively, as illustrated in Table 3.

TABLE 3

| | Decisions |
|---|---|
| a₁ | {do nothing} |
| a₂ | {offer a 10 GB data package at a price of RMB 20} |
| a₃ | {offer a 50 GB data package at a price of RMB 50} |
| a₄ | {offer 5G package upgrade} |
| a₅ | {offer a 10 GB data package at a price of RMB 20 and 50 GB data |
| | package at a |
| a₆ | price of RMB 50} |
| a₇ | {offer a 50 GB data package at a price of RMB 50 and 5G package |
| | upgrade} |
| a₈ | {offer a 10 GB data package at a price of RMB 20, 50 GB data |
| | package at a price |
| | of RMB 50, and 5G package upgrade} |

In some embodiments, supposing the number of atom actions that can be provided by the user (e.g., an operator, a bank, etc.) is N, it may be determined that the number of the decisions included in the set of decisions is N^{th} power of 2, i.e., 2^{N}. Alternatively, the number of the decisions in the set of decisions may be further reduced based on the background source nodes in the causal graph. For example, a customer living in “Sichuan” is highly unlikely interested in “typhoon alarm.” As such, the order of magnitude of the decisions may be significantly reduced, which may facilitate the subsequent training process, thereby improving efficiency.

As such, in the embodiments of the present disclosure, use of the causal model not only takes into account static characteristics of the customer such as age and gender, but also takes into account the stochasticity of different or same customers with like attributes at different time, thereby improving system performance. Moreover, it is understood that the preconstructed causal model includes a determined causality, some spurious correlations may be ruled out, such that the order of magnitude of the decisions included in the determined set of decisions are reduced and more rational.

It is noted that the set of perception categories described above with reference to Table 1 is only exemplary. In an actual scenario, the set of perception categories may have other forms. For example, a customer experience index of interest may include word of mouth. For example, the satisfaction or loyalty may be classified into more granularities. Correspondingly, the number of perception categories included in the set of perception categories may be larger, which is not limited herein.

In some embodiments of the present disclosure, the transition function may be determined based on a training set, and the reward function may also be determined based on a training set.

The training set may comprise multiple data items. The data item dᵢ in the training set may be represented as (sᵢ,aᵢ,s′ᵢ,rᵢ,x). The meaning of the data item dᵢ is: for the attribute information x, the current perception category sᵢ is transitioned to the transitioned perception category s′ᵢ after applying the decision aᵢ; and corresponding reward rᵢ is gotten by applying the decision aᵢ during the process of transitioning the perception category from sᵢ to s′ᵢ.

It is understood that sᵢ and s′ᵢ belong to the set of perception categories; moreover, the sᵢ and s′ᵢ in the same data item dᵢ may be identical or different. In some embodiments, the user may obtain the customer's perception category s₁ prior to applying the decision aᵢ and the perception category s′ᵢ after applying the decision aᵢ according to a pre-constructed satisfaction evaluation model (a causal model).

It is understood that the corresponding reward may be determined based on the user's actual cost, or an evaluated value of the current perception category. Specifically, the user may record corresponding costs during the procedure of applying the strategy.

As an example, the user may obtain a training set including multiple data items by collecting data of a large number of customers and/or customers of different periods.

In some embodiments, determining a transition function based on the train set may comprise: summing the frequency of data items with identical perception categories and decisions in the training set, and further determining a probability.

For example, for those data items with the attribute information being specific x (e.g., x=(mid, biz, male)), the total number of the data items including the current perception category s₁, and the decision a₁ may be determined, e.g., N₁. The total numbers of the data items including the current perception category s₁ and the decision a₁, the transitioned perception categories s₁ to s₅ may be counted, e.g., N₁₁ to N₁₅, respectively. Then, the probability (which, for example, is represented as p) of perception category transition from the perception category s₁ incurred from applying the decision a₁ may be determined, expressed by the equation (1) below:

$$p ( {s}^{′} \vert {s}_{1} , {a}_{1} , x ) = \{ \begin{matrix}\frac{{N}_{11}}{{N}_{1}} , & {s}^{′} = {s}_{1} \\ \frac{{N}_{12}}{{N}_{1}} , & {s}^{′} = {s}_{2} \\ \frac{{N}_{13}}{{N}_{1}} , & {s}^{′} = {s}_{3} \\ \frac{{N}_{14}}{{N}_{1}} , & {s}^{′} = {s}_{4} \\ \frac{{N}_{15}}{{N}_{1}} , & {s}^{′} = {s}_{5}\end{matrix} \qquad ( 1 )$$

Specifically, p(s′|s₁, a₁, x) indicates the probability for the attribute information x to transition from the current perception category s₁ to the transitioned perception category s′ after applying the decision a₁. It is understood that what has been described above is only a description of the probability function p(s′|s₁, a₁, x) of the perception category transition for s₁, and a₁. The transition function in the embodiments of the present disclosure may include probability functions of perception category transitions for various s and a. In other words, the transition function includes multiple probability functions. For example, the equations (2) to (5) below illustrate 4 exemplary probability functions:

$$p ( {s}^{′} \vert {s}_{1} , {a}_{1} , x ) = \{ \begin{matrix}0.7 , & {s}^{′} = {s}_{1} \\ 0.2 , & {s}^{′} = {s}_{2} \\ 0.1 , & {s}^{′} = {s}_{3} \\ 0 , & {s}^{′} = {s}_{4} \\ 0 , & {s}^{′} = {s}_{5}\end{matrix} \qquad ( 2 )$$

$$p ( {s}^{′} \vert {s}_{2} , {a}_{1} , x ) = \{ \begin{matrix}0 , & {s}^{′} = {s}_{1} \\ 0.6 , & {s}^{′} = {s}_{2} \\ 0.2 , & {s}^{′} = {s}_{3} \\ 0.1 , & {s}^{′} = {s}_{4} \\ 0.1 , & {s}^{′} = {s}_{5}\end{matrix} , \qquad ( 3 )$$

$$p ( {s}^{′} \vert {s}_{1} , {a}_{2} , x ) = \{ \begin{matrix}0.9 , & {s}^{′} = {s}_{1} \\ 0.1 , & {s}^{′} = {s}_{2} \\ 0 , & {s}^{′} = {s}_{3} \\ 0 , & {s}^{′} = {s}_{4} \\ 0 , & {s}^{′} = {s}_{5}\end{matrix} , \qquad ( 4 )$$

$$p ( {s}^{′} \vert {s}_{2} , {a}_{2} , x ) = \{ \begin{matrix}0.1 , & {s}^{′} = {s}_{1} \\ 0.8 , & {s}^{′} = {s}_{2} \\ 0.1 , & {s}^{′} = {s}_{3} \\ 0 , & {s}^{′} = {s}_{4} \\ 0 , & {s}^{′} = {s}_{5}\end{matrix} . \qquad ( 5 )$$

As an example, s₁ to s₅ may be those shown in Table 1 above, and a₁ and a₂ may be those shown in Table 3 above. However, it is noted that the embodiments of the present disclosure have no limitations thereto.

Alternatively, in the embodiments of the present disclosure, the transition function may be determined based on a training set using a preconstructed neural network model. In this way, the operations of determining the transition function can be decreased, thereby improving automatic performance.

In some embodiments, determining a reward function based on the training set may comprise: determining the reward function based on the cost included in the data items in the training set.

For example, the reward function may be represented as R(s, a), where s represents the current perception category, a represents the decision applied. In some examples, it may be determined that R(s, a)=c·f(s)/cost(a). In the equation of reward function, c may be a predefined constant, e.g., c=1. cost(a) represents the cost consumed when the user applies the strategy a. f(s) may be a predetermined function related to s, which, for example, may be set with f(s₁)>f(s₂)>f(s₃)>f(s₄)>f(s₅), while its specific value may be arbitrarily chosen. As an example, f(s) may be valued according to equation (6) below:

$$f ( s ) = \{ \begin{matrix}10 , s = {s}_{1} \\ 8 , s = {s}_{2} \\ 5 , s = {s}_{3} \\ 2 , s = {s}_{4} \\ - 5 , s = {s}_{5}\end{matrix} . \qquad ( 6 )$$

However, it is understood that the exemplary value of f(s) above is only illustrative. In an actual scenario, the value of f(s) may be arbitrarily chosen, as long as it satisfies f(s₁)>f(s₂)>f(s₃)>f(s₄)>f(s₅). In addition, it is understood that the embodiments of the present disclosure may also use a more complexed reward function with the cost considered, which will not be enumerated herein for the sake of brevity.

In some embodiments of the present disclosure, the decision model 130 may be obtained through training at block 220. Specifically, the decision model 130 may be trained using the set of perception categories, the set of decisions, the transition function, and the reward function.

During the training period, a target function may be an expected value of a cumulative reward of one or more continuous phases. As an example, the target function may be expressed according to the equation (7) below:

π*ₓ=argmax_{π}_{ₓ}E[Σₜ₌₀^{H}R(sₜ,πₓ(sₜ))|s₀,x] (7)

In the equation above, argmax represents the parameter π*ₓ when yielding the maximum output, E represents expectation, t denotes time, H represents the range of time interval, R represents the reward function, sₜ represents the corresponding transitioned perception category after applying πₓ(sₜ)(or a) at phase t, s₀ represents the current perception category, and x represents the attribute information.

It is understood that the decision model in the embodiments of the present disclosure may be based on a Markov Decision Process (MDP).

In this way, the trained decision model 130 may be derived via the training process in the embodiments of the present disclosure. Specifically, the MDP may be resolved via value iteration and decision iteration, thereby obtaining a decision solution.

The decision solution may correspond to the attribute information, for representing estimated values corresponding to respective decisions applied at the current perception category. Alternatively, the estimated value may be determined based on the aforementioned target function. Exemplarily, the estimated value of the decision a may be expressed as Qₓ(s, a) when the attribute information is x and the current perception category is s.

Take, for example, the attribute information set forth in Table 2. For the attribute information (represented as x) with an age of middle (mid), a job of businessman (biz), and a gender of male (male), a decision solution corresponding to the attribute information x=(mid, biz, male) is set forth in Table 4 below.

TABLE 4

x = (mid, biz, male)

| | a₁ | a₂ | a₄ | a₇ |
|---|---|---|---|---|
| s₁ | 89 | 79 | 34 | 50 |
| s₂ | 110 | 15 | 57 | 90 |
| s₃ | 77 | 23 | 67 | 115 |
| s₄ | 21 | 55 | −1 | 7 |

s₁ to s₄ set forth in Table 4 may be those set forth in the aforementioned Table 1; and a₁, a₂, a₄, and a₇ set forth in Table 4 may be those set forth in the aforementioned Table 3. It is understood that Table 4 is only illustrative. In an actual scenario, the decision solution may include the corresponding estimated values from applying each decision in the set of decisions. For example, Q_{(mid,biz,male)}(s₁, a₁)=⁸⁹.

Alternatively, in some other embodiments, an optimal decision solution may be further derived. Specifically, the optimal decision (e.g., represented as a*) corresponding to each current perception category may be determined based on Table 4. For example, the optimal decision solutions may be derived based on Table 4, as set forth in Table 5 below.

TABLE 5

| | x = (mid, biz, male) | |
|---|---|---|
| | a* | ${{V}_{x} ( s ) = max {Q}_{x} ( s , a )}_{a}$ |
| s₁ | a₁ | 89 |
| s₂ | a₁ | 110 |
| s₃ | a₇ | 115 |
| s₄ | a₂ | 55 |

Alternatively, in the optimal decision solutions set forth in Table 5, the estimated values corresponding to respective optimal decisions are further illustrated in column 3. It is understood that the optimal decision solutions may not include the estimated values corresponding to the optimal decisions in actual scenarios. For example, supposing the attribute information including the age of senior (senior), the job of businessman (biz), and the gender of male (male), the optimal decision solutions derived based on the decision solutions corresponding to the attribute information x=(senior, biz, male) are set forth in Table 6 below.

TABLE 6

| | x = (senior, biz, male) |
|---|---|
| | a* |
| s₁ | a₁ |
| s₂ | a₂ |
| s₃ | a₂ |
| s₄ | a₇ |

Therefore, the target function in the embodiments of the present disclosure considers an expectancy of the rewards, such that the stochasticity of the customer experience can be better reflected, enabling the decision model to determine the target decision more accurately.

In addition, the target function in the embodiments of the present disclosure considers a culmination of rewards, such that it weighs a long-term mechanism in a better manner. Generally, after the user applies a decision, it takes a certain time period to affect the customer experience. The customer experience is a cumulative effect, and after reflection of the customer experience, the customer satisfaction might decrease gradually. Therefore, the embodiments of the present disclosure can assure a more efficient management of the customer by considering the long-term effect via culmination.

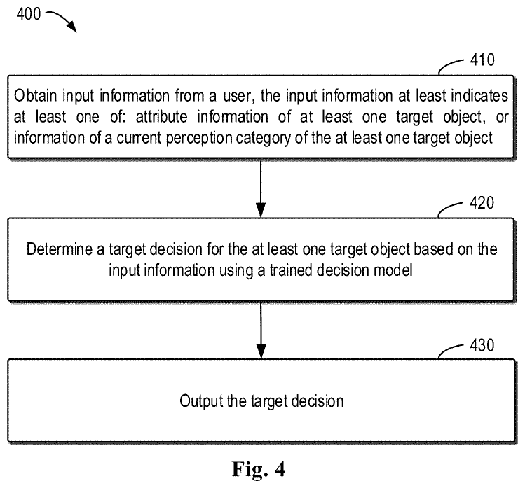

Example training process of the decision model 130 has been described above with reference to FIG. 2 and FIG. 3. With the trained decision model 130, the target decision (which, for example, may be represented as a*) for the target object (e.g., customer) can be determined, and the decision model 130 not only considers the stochasticity but also considers the long-term mechanism, which thus can avoid issues such as over-service or inefficient management outcome. An example use process of the decision model 130 will be described hereinafter with reference to FIG. 4.

FIG. 4 illustrates a flowchart of an example use process 400 according to embodiments of the present disclosure. For example, the method 400 may be implemented by the computing device 110 as illustrated in FIG. 1. It is understood that the method 400 may further comprise an additional block(s) that is(are) not shown, and/or may omit some of the shown blocks. The scope of the present disclosure is not limited thereto.

At block 410, input information from a user is obtained, the input information at least indicates at least one of: attribute information of at least one target object, or information of a current perception category of the at least one target object.

At block 420, a target decision for the at least one target object is determined based on the input information using a trained decision model.

At block 430, the target decision is outputted.

In the embodiments of the present disclosure, the user may determine customer information including attribute information of respective customers and information of the corresponding current perception category. In some examples, the user may obtain the customer information via information collection (e.g., questionnaire, etc.). In some other embodiments, the user may obtain the attribute information of respective customers via information collection, and further determine the information of the corresponding current perception category based on a causal model. It is noted that the customer information may be also be obtained via other manners, which are not enumerated here.

As an example, it may be assumed that the attribute information of respective customers and the information of the corresponding perception category may be represented in a form set forth in Table 7, wherein x represents the attribute information, and s represents the information of the current perception category. As shown in Table 7, the age in the attribute information includes middle age (mid), young age (young), and senior age (senior); the job includes businessman (biz) and government employee (gov); and the gender includes male (male) and female (female).

TABLE 7

| | |
|---|---|
| | s |
| x | PERCEPTION |

| ID | AGE | JOB | GENDER | CATEGORY |
|---|---|---|---|---|
| 1 | mid | biz | male | s₃ |
| 2 | mid | biz | male | s₃ |
| 3 | mid | biz | male | s₁ |
| 4 | young | gov | female | s₄ |
| 5 | senior | biz | male | s₄ |
| 6 | senior | biz | male | s₄ |

It is understood that the customer information set forth in Table 7 is only illustrative; in an actual scenario, the customer information may include information of more customers, and the classification granularity for the attribute information can be larger. Optionally, the customer information may further include other information of the customer, e.g., name, which will not be enumerated in the embodiments of the present disclosure.

In some embodiments, the input information may include ID, such that a target object may be determined based on the customer information. It is understood that if the input information includes more IDs, multiple target objects may be determined accordingly.

In some embodiments, the input information may include attribute information, e.g., “Gender: male,” for example “x=(mid, biz, male),” such that one or more target objects may be determined based on the customer information.

In some embodiments, the input information may include information of the current perception category, e.g., “s₄,” such that one or more target objects may be determined based on the customer information.

In some embodiments, the input information may comprise attribute information and the information of the current perception category, e.g., “Gender: male, Current Perception Category: s₄,” or “x=(mid, biz, male), s₄,” such that one or more target objects may be determined based on the customer information.

It is understood that the input information may have other forms. Specifically, the user may determine one target object or one type of target objects based on the actual needs, and then enter the input information indicating the one target object or the one type of target objects. In some examples, one target object or one type of target objects may be determined via a feature extraction, which may be a subset of all customers indicated by the customer information set forth in Table 7. In some examples, the target object may also be referred to as a target customer or otherwise, which is not limited herein.

Hereinafter, multiple embodiments of determining a target decision at block 420 may be described separately based on multiple examples.

In some embodiments, one or more target objects may be determined based on the input information, and the target decision for each target object may be further determined.

As an example, the target decisions for respective of the target objects may be determined, respectively. In other words, the processes of determining the target decision are mutually independent for different target objects, and the target decisions determined for different target objects may be identical or different.

Take one target object as an example. The attribute information and current perception category of the target object may be determined based on the input information, and the target decision corresponding to the current perception category may be determined based on a decision solution corresponding to the attribute information derived from the trained decision model.

For example, supposing the input information is “ID=3,” it may be determined from Table 7 that the attribute information of the target object is x=(mid, biz, male) and the current perception category is s₁. For another example, supposing the input information is “age=young,” the target object with ID=4 may be determined from Table 7, whose attribute information is x=(young, gov, female) and current perception category is s₄.

The corresponding decision solution derived from the decision model may be found based on the attribute information of the target object. For example, the decision solution corresponding to the attribute information x=(mid, biz, male) for the target object ID=3 may be one set forth in Table 4 or Table 5. Furthermore, a line corresponding to the current perception category may be found from the decision solution, whereby to determine the target decision.

For example, as set forth in Table 5, the first line corresponds to the current perception category s₁, whereby it may be determined that the target decision is a₁. It is seen in conjunction with Table 3 that the target decision is “do nothing.”

For another example, the decision solution may indicate estimated values corresponding to various decisions applied at the current perception category, where the estimated value corresponding to the target decision is greater than the estimated value corresponding to any other decision. In other words, the decision corresponding to the maximum estimated value may be determined as the target decision. Take Table 4 as an example, the first line corresponds to the current perception category s₁, the maximum estimated value is 89, and the value 89 corresponds to the decision a₁; therefore, it may be determined that the target decision is a₁. It is seen from Table 3 that the target decision is “do nothing.”

As an example, the target decision may be determined collectively for a type of target objects having the same attribute information and the same current perception category. In other words, if there are multiple target objects with the same attribute information and the same current perception category, the multiple target objects may be deemed as a group, and the target decision may be determined collectively for the group.

For example, supposing the input information is “x=(senior, biz, male),” then two target objects with ID 5 and ID 6 may be determined from Table 7, where the attribute information of the two target objects is x=(senior, biz, male) and the current perception category of the two target objects is s₄.

For the two target objects, the corresponding decision solution already derived based on the decision model may be found based on the common attribute information. For example, the decision solution may be the one set forth in Table 6. Furthermore, a line corresponding to the common current perception category (i.e., s₄) may be found from the decision solution, whereby to determine the target decision, i.e., a₇.

As such, for multiple target objects of the same type with identical attribute information and identical current perception category, it becomes unnecessary to repetitively determine the target decision therefor, whereby to lower hardware complexity, shorten processing time, improve processing efficiency, and further enhance customer experience.

It is understood that the method of determining a target decision for a single target object and the method of determining a target decision collectively for multiple target objects of the same type may be used in combination. For example, supposing the input information is “x=(mid, biz, male),” three target objects with IDs=1, 2 and 3 may be determined from Table 7, where for the target object with ID=3, its target decision may be independently determined (e.g., the target decision may be determined as a₁ based on Table 4 or Table 5), and for the two target objects with IDs=1 and 2, their target decision may be determined collectively (e.g., the target decision may be determined as a₇ based on Table 4 or Table 5).

Additionally, it is understood that although the target decision determined in some examples above includes one decision, i.e., the optimal decision with the maximum estimated value, the embodiments of the present disclosure are not limited thereto. In some other embodiments, it may also be determined that multiple decisions corresponding to the current perception category are multiple target decisions.

For example, for the target object with ID=3 in Table 7, multiple target decisions (including a₁, a₂, a₄ and a₇) may be determined based on the decision solution set forth in Table 4.

Alternatively, in some examples, the estimated values corresponding to the multiple target decisions may also be determined, and then the multiple target decisions and the multiple estimated values corresponding to the multiple target decisions may be outputted at block 430. Optionally, in some other embodiments, multiple target perception categories transitioned from the current perception category after applying the multiple target decisions may also be determined based on the trained decision model. And then the multiple target decisions and the multiple target perception categories corresponding to the multiple target decisions may be outputted at block 430.

Alternatively, in some examples, multiple target decisions corresponding to multiple phases may be determined at block 420 and then the multiple target decisions corresponding to the multiple phases may be outputted at block 430. For example, multiple target decisions with a specific sequence may be outputted, where the specific sequence is determined based on multiple phases. Specifically, as described above, the target function used in training the decision model may be an expectancy of a cumulative reward of multiple continuous phases; then for multiple continuous phases, the optimal decision may be determined phase-wise, thereby obtaining the multiple target decisions corresponding to the multiple continuous phases. In this way, a series of long-lasting decisions may be provided to realize a long-term mechanism for maintaining or improving customer satisfaction.

In this way, various possible decision options may be provided to the user, such that the user may choose a to-be-applied decision dependent on actual needs. In addition, the user may understand a better implementation mode of the strategy more globally and intuitively, and then the strategy may be carried out gradually dependent on actual circumstances.

In some embodiments, a target decision may be determined for all target objects. In other words, a common target decision for all target objects is determined.

Specifically, the current perception categories of respective of the multiple target objects may be determined based on the input information. The distribution information of the current perception categories of the multiple target objects may be determined, where the distribution information indicates a proportion of the number of target objects belonging to respective current state categories to the number of the multiple target objects. Furthermore, a common target decision for the multiple target objects may be determined based on the distribution information and the decision solutions corresponding to respective attribute information of the multiple target objects.

For example, suppose the multiple target objects corresponding to the input information include four target objects with IDs=1, 3, 5, and 6 in Table 7. For example, the input information may be “ID=1, 3, 5, 6.”

With reference to Table 7, the current perception categories of the four target objects with IDs=1, 3, 5, and 6 are s₃, s₁, s₄, and s₄, respectively. The probability distribution information of the current perception categories of the multiple target objects may be determined, represented as p(s), which indicates the proportion of the number of target objects having the current perception category s to the total number of the multiple target objects. Specifically, p(s₁)=0.25, p(s₂)=0, p(s₃)=0.25, and p(s₄)=0.5.

With reference to Table 7, the attribute information of the four target objects with IDs=1, 3, 5, and 6 is x=(mid, biz, male), x=(mid, biz, male), x=(senior, biz, male), and x=(senior, biz, male) respectively.

For each of the multiple target objects, a decision solution corresponding to the attribute information may be determined, and multiple decisions corresponding to the current perception category and the estimated values of the multiple decisions may be further determined. Take the target object with ID=1 as an example, its decision solution may be that set forth in Table 4, and then the line where s₃ is located is further determined, i.e., the multiple decisions for the target object with ID=1 are a₁, a₂, a₄, and a₇, and the estimated values of the multiple decisions are 77, 23, 67, and 115 respectively. Take the target object with ID=3 as an example, its decision solution may be that set forth in Table 4, and then the line where s₁ is located is further determined, i.e., the multiple decisions for the target object with ID=1 are a₁, a₂, a₄, and a₇, and the estimated values of the multiple decisions are 89, 79, 34, and 50 respectively. It is understood that a similar determination may be made for each of the remaining target objects in the multiple target objects, which will not be enumerated one by one here.

A target decision may be determined based on the proportion of respective current perception category indicated by the distribution information, the multiple decisions of the target object objects at respective current perception category as well as their corresponding estimated values. Specifically, the target decision may be represented as ã*, which may be determined by

$${\tilde{a}}^{⋆} = {arg max}_{a} p ( s ) \cdot {Q}_{x} ( s , a ) .$$

As such, the identical target decision may be determined for multiple target objects in the embodiments of the present disclosure, which realizes equilibrium between respective optimal strategies of the multiple target objects, whereby the subsequent decision execution can be simplified.

In some embodiments, when determining the target decision, other determination conditions may be further considered, e.g., information of a cost threshold and/or information of a number threshold. It is understood that the information of the cost threshold and/or the information of the number threshold may be pre-defined and stored, or may be inputted by the user; for example, the input information includes the information of the cost threshold and/or the information of the number threshold.

In some embodiments, the cost threshold may represent the maximum cost expected to consume or the cost range expected to consume. Accordingly, it may be understood that when determining a target decision, the total cost corresponding to the target decision should satisfy the cost threshold, e.g., the total cost does not exceed the maximum cost or the total cost falls within the cost range.

Exemplarily, a more detailed illustration will be made with the cost threshold representing the maximum cost. Specifically, the input information may further include the information of the cost threshold, and the information of the cost threshold represents the upper limit of the cost consumed while applying the target decision (hereinafter referred to as maximum cost).

Specifically, for the one target object corresponding to the input information, the attribute information and the current perception category of the target object may be determined. Based on the decision solution corresponding to the attribute information of the target object, multiple decisions corresponding to the current perception category of the target object are determined. Afterwards, a target decision may be chosen from the multiple decisions. For example, one or more decisions with a cost not exceeding the maximum cost may be determined from the multiple decisions, and then the decision with the highest estimated value among the one or more decisions is chosen as the target decision. Or, the one or more decisions may be taken as the target decision. Or, the decision with the lowest cost among the one or more decisions may be chosen as the target decision.

Specifically, for multiple target objects corresponding to the input information, the attribute information and information of current perception categories of respective of the multiple target objects may be determined. Multiple decisions corresponding to the current perception categories of the multiple target objects are determined based on the decision solutions corresponding to the attribute information of respective of the target objects. Furthermore, the target decisions for respective of the target objects may be determined from the multiple decisions of the respective of the target objects, where a total cost of applying the respective target decision for respective of the multiple target objects does not exceed the maximum cost.

Take Table 7 as an example. Supposing the input information includes “s₄”, then it may be determined based on Table 7 that multiple target objects corresponding to the input information include three target objects with IDs=4, 5, 6. Accordingly, the respective attribute information and current perception category of each of the multiple target objects may be determined.

The multiple target objects may be classified into multiple groups based on the attribute information, where the target objects in a same group have the same attribute information and the target objects in different groups have different attribute information. It is understood that different attribute information means at least one item among the age, job, or gender is different.

For example, with reference to Table 7, the three target objects with IDs=4, 5, 6 include two types of attribute information, which are x=(young, gov, female) and x=(senior, biz, male), respectively. Accordingly, the target object with ID=4 belong to a group, and the two target objects with IDs=5, and 6 belong to another group.

For each group in the multiple groups, an optimal decision with a maximum estimated value and the cost of applying the optimal decision may be determined based on a decision solution corresponding to the attribute information of the group.

For example, multiple decisions corresponding to the current perception category s₄ may be determined based on the decision solution corresponding to the attribute information x=(young, gov, female), and then the optimal decision may be determined from the multiple decisions, where it is assumed that the estimated value of the optimal decision is 111, and the cost is 50. For example, the multiple decisions corresponding to the current perception category s₄ may be determined based on the decision solution corresponding to the attribute information x=(senior, biz, male), and then the optimal decision may be determined therefrom, where it is assumed that the estimated value of the optimal decision is 98 and the cost is 30. The examples may be specifically represented in Table 8 below.

TABLE 8

| | | Estimated | |
|---|---|---|---|
| | Number of | value of | Cost of |
| | target | optimal | optimal |
| Attribute information | objects | decision | decision |
| x = (young, gov, female) | 1 | 111 | 50 |
| x = (senior, biz, male) | 2 | 98 | 30 |

The target decision with a total cost not exceeding (lower than or equal to) the maximum cost may be determined based on the estimated value of the optimal decision and the cost of the optimal decision of respective group in the multiple groups.

For example, as illustrated in Table 8 above, although the estimated value of the optimal decision for attribute information x=(young, gov, female) is larger (i.e., 111), the number of target objects in the group with the attribute information x=(senior, biz, male) is 2, and 98×2 is greater than 111; then it may be determined that the target decision for the group with attribute information x=(young, gov, female) is the optimal decision determined above, while the target decision for the group with attribute information x=(young, gov, female) is “do nothing.”

It is understood that the process of determining a target decision as described with reference to Table 8 is only illustrative. In an actual scenario, a problem of determining a target decision with the information of the cost threshold considered may be constructed to a knapsack problem, and then the target decision of respective group may be obtained by resolving the knapsack problem. Specific implementations thereof may refer to various conventional technologies for resolving knapsack problems, which will not be detailed here.

In some embodiments, the input information may further include information of a number threshold. Supposing there are multiple target objects corresponding to the input information, the information of the number threshold represents the upper limit (or maximum value) of the proportion of the number of target objects which are subjected to target decision application to the total number of the multiple target objects.

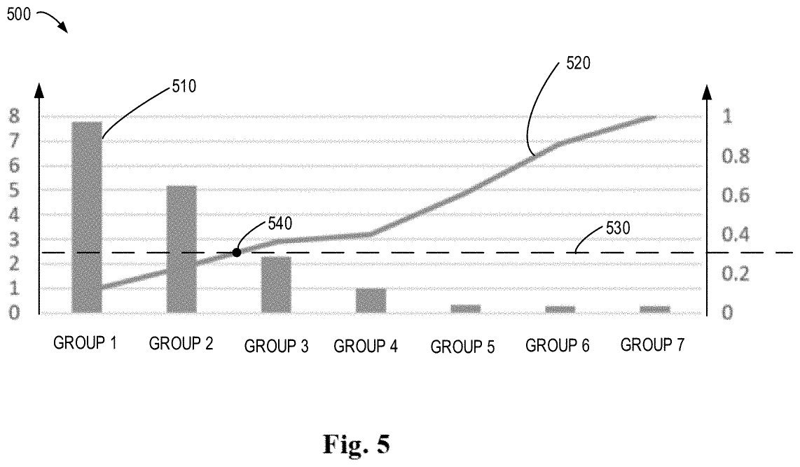

Specifically, for the multiple target objects corresponding to the input information, the attribute information and the information of the current perception category with respect to each of the target objects may be determined. Multiple decisions corresponding to the current perception category of respective target objects are determined based on the decision solution corresponding to the attribute information of respective target objects. Furthermore, the optimal decision and the estimated value of the optimal decision for respective target objects may be determined from the multiple decisions for respective target objects. Then, a part of target objects among the multiple target objects may be determined, where the number of the part of target objects does not exceed the number threshold. Moreover, the respective optimal decisions of the part of target objects may serve as the respective target decisions for the part of target objects. Optionally, the target decision for remaining target objects other than the part of target objects in the multiple target objects may be determined as “do nothing.” In some embodiments, the part of target objects may be determined based on a utility ratio, which will be described in detail with reference to FIG. 5.

For example, referring to Table 7 and supposing the input information includes “s₄,” it may be determined based on Table 7 that multiple target objects corresponding to the input information include three target objects with IDs=4, 5, 6, and then the respective attribute information and current perception category of the multiple target objects may also be determined accordingly.

Multiple target objects may be classified into multiple groups based on the attribute information, where the target objects in a same group have identical attribute information and the target objects in different groups have different attribute information. It is understood that different attribute information means that at least one item of the age, job, or gender is different.

For example, with reference to Table 7, the three target objects with IDs=4, 5, 6 include two types of attribute information, which are x=(young, gov, female) and x=(senior, biz, male), respectively. Correspondingly, the target object with ID=4 belongs to a group, and the two target objects with IDs=5, and 6 belong to another group.

For each group in the multiple groups, an optimal decision with a maximum estimated value and the cost of applying the optimal decision may be determined based on the decision solution corresponding to the attribute information of the group. Then, a utility ratio of the optimal decision may be further determined, i.e., the ratio of the estimated value of the optimal decision to the cost of applying the optimal decision.

For example, multiple decisions corresponding to the current perception category s₄ may be determined based on the decision solution corresponding to the attribute information x=(young, gov, female), and then the optimal decision may be determined from among the multiple decisions, where it is assumed that the estimated value of the optimal decision is 111 and the cost is 50; accordingly, the utility ratio is 111/50. For example, the multiple decisions corresponding to the current perception category s₄ may be determined based on the decision solution corresponding to the attribute information x=(senior, biz, male), and the optimal decision is determined therefrom, where it is assumed that the estimated value of the optimal decision is 98 and the cost is 30; accordingly the utility ratio is 98/30. The examples are illustrated in Table 9 below.

TABLE 9

| | | Estimated | | |
|---|---|---|---|---|
| | Number of | value of | Cost of | |
| | target | optimal | optimal | Utility |
| Attribute information | objects | decision | decision | ratio |
| x = (young, gov, female) | 1 | 111 | 50 | 111/50 |
| x = (senior, biz, male) | 2 | 98 | 30 | 98/30 |

The multiple groups may be ranked from high to low according to the utility ratio. Furthermore, the cumulative distribution function (CDF) of the number of target objects may be represented according to the number of target objects in respective group based on the multiple groups sorted as per utility ratio. Then, one or more target groups in the corresponding multiple groups may be determined based on the location of the number threshold on the CDF. In this way, it may be determined that the respective target decisions for the one or more target groups is the previously determined optimal decision, respectively, while the target decision for other groups in the multiple groups is “do nothing.”

FIG. 5 illustrates a schematic diagram 500 of determining a target group based on the information of a number threshold. In FIG. 5, the histogram 510 represents the utility ratios of respective groups, where the left-side longitudinal coordinate represents the utility ratio and the transverse coordinate represents multiple groups (including group 1 to group 7), and the multiple groups are sorted in a descending order as per utility ratios. The curve 520 represents the CDF of the number of target objects of respective groups, and the right-side longitudinal coordinate represents the proportion corresponding to the CDF. The straight dotted-line 530 represents the number threshold (e.g., 30%). The target group may be determined based on the intersection 540 of the curve 520 and the dotted-line 530. Specifically, the utility ratio of the target group is greater than the utility ratio corresponding to the intersection 540. With reference to FIG. 5, the target groups are the groups to the left of the intersection 540, i.e., group 1 and group 2. In this way, the target decision for group 1 and the target decision for group 2 may be determined, and nothing is done for the remaining groups 3 to 7. In other words, the target decisions for groups 3 to 7 are “do nothing.”

As such, the embodiments of the present disclosure enable a determination of the target decision based on determination conditions such as information of a cost threshold and/or information of a number threshold, whereby the cost of applying the target decision can be lowered.

In some embodiments, there may further comprise: obtaining an updated perception category after applying the target decision to the target object; constructing a data item based on the current perception category, the target decision, and the updated perception category; and adding the data item into the training set for training the decision model so as to update the decision model.

Exemplarily, the target decision may be applied to the target object by the user or by another third party of interest. Optionally, corresponding cost may be recorded when applying the target decision to the target object at the current perception category. Moreover, the data item may be constructed based on the current perception category, the target decision, the updated perception category, and the corresponding cost.

Additionally, it is understood that after applying the target decision, the updated perception category may serve as the current perception category, and then the process 400 illustrated in FIG. 4 is executed again. In this way, a long-term customer experience for the target object can be maintained.

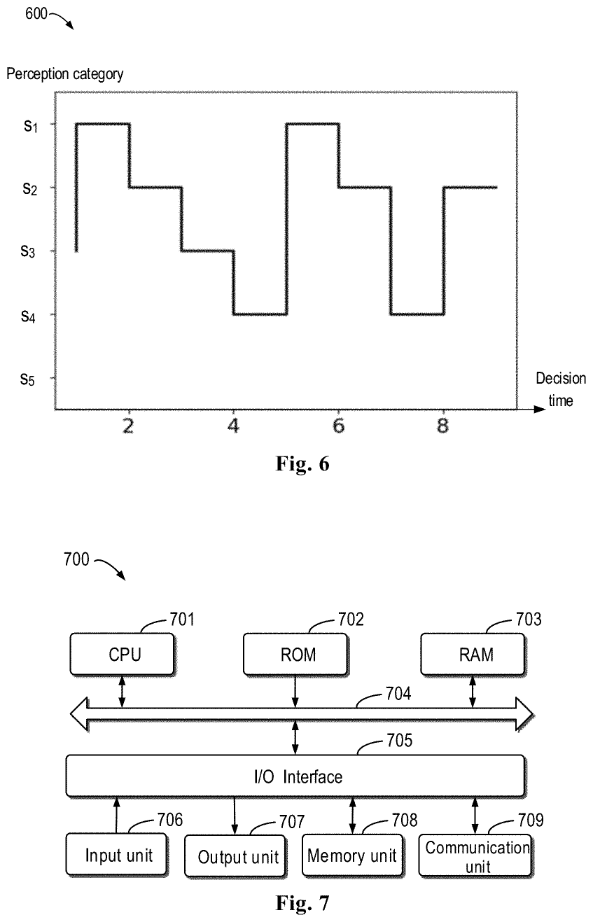

As an example, FIG. 6 illustrates a schematic diagram of a transition 600 of the current perception category incurred from applying the decision. In FIG. 6, the transverse axis represents the decision time, and the longitudinal axis represents the perception category.

As such, by applying different decisions at different period, the effective management of the perception category (e.g., satisfaction) can be implemented to thereby maintain the perception category (e.g., satisfaction) within a reasonable range expected by the user, preventing the satisfaction from decreasing beyond the range.

In this way, a decision model may be obtained through training, and may be used for determining the target decision based on the current perception category. The decision model may not only consider static characteristics of the customer such as age and gender but also may consider the stochasticity of reactions of different customers or same customer with identical attributes at different time, thereby improving system performance. The decision model in the embodiments of the present disclosure not only consider stochasticity but also consider a long-term mechanism, which may avoid circumstances such as over-service or inefficient management. In the embodiments of the present disclosure, the customer experience may be efficiently managed by applying the determined target decision, e.g., may assure that the customer satisfaction is maintained within a specific range.

In some embodiments, a computing device comprises a circuit configured to perform the following operations: obtaining input information from a user, the input information at least indicating at least one of: attribute information of at least one target object, or information of a current perception category of the at least one target object; determining a target decision for the at least one target object based on the input information using a trained decision model; and outputting the target decision.

In some embodiments, the computing device comprises a circuit configured to perform the following operations: determining the attribute information and the current perception category of the at least one target object based on the input information; and determining the target decision corresponding to the current perception category of the at least one target object based on a decision solution derived from the trained decision model and corresponds to the attribute information of the at least one target object.

In some embodiments, the decision solution at least indicates estimated values corresponding to respective decisions applied at the current perception category, where an estimated value corresponding to the target decision is greater than each of estimated values corresponding to the remaining decisions.

In some embodiments, the computing device comprises a circuit configured to perform the following operations: determining a plurality of target decisions to be applied for a transition of the at least one target object from the current perception category to a plurality of target perception categories based on the decision solution corresponding to the attribute information of the at least one target object; and outputting the plurality of target decisions for the at least one target object and the plurality of target perception categories corresponding to the plurality of target decisions.

In some embodiments, the at least one target object corresponding to the input information comprises a plurality of target objects, the input information further comprises information of a number threshold, and the computing device comprises a circuit configured to perform the following operations: determining, based on decision solutions derived from the trained decision model and correspond to attribute information of respective target objects of the plurality of target objects, optimal decisions of the respective target objects and estimated values of the optimal decisions; determining a part of the plurality of target objects based on the optimal decisions of the respective target objects and the estimated values of the optimal decisions, a number of the part of the of target objects not exceeding the number threshold; and determining that the target decision for the part of target objects is an optimal decision for the part of target objects.

In some embodiments, the at least one target object corresponding to the input information comprises a plurality of target objects, the input information further comprises information of a cost threshold, and the computing device comprises a circuit configured to perform the following operations: determining, based on decision solutions derived from the trained decision model and correspond to attribute information of respective target objects of the plurality of target objects, candidate decisions for the respective target objects; and determining the target decision for the respective target objects from among the candidate decisions for the respective target objects, a total cost of applying respective target decisions to the respective target objects of the plurality of target objects meeting the cost threshold.

In some embodiments, the at least one target object corresponding to the input information comprises a plurality of target objects, and the computing device comprises a circuit configured to perform the following operations: determining distribution information of the current perception category of the plurality of target objects, the distribution information indicating a proportion of a number of target objects belonging to respective current perception categories to a number of the plurality of target objects; and determining the target decision for the plurality of target objects based on the distribution information and decision solutions derived from the trained decision model and correspond to attribute information of respective target objects of the plurality of target objects.

In some embodiments, the computing device comprises a circuit configured to perform the following operations: determining a plurality of target decisions corresponding to a plurality of phases for at least one target object based on the input information; and outputting the plurality of target decisions corresponding to the plurality of phases.

In some embodiments, the computing device comprises a circuit configured to perform the following operations: constructing a training set, the training set comprising a plurality of data items, each of the plurality of data items comprising: attribute information, a current perception category, a decision, a transitioned perception category for the attribute information from the current perception category after applying the decision, and corresponding reward information during transitioning from the current perception category to the transitioned perception category; and generating the trained decision model at least based on the training set.

In some embodiments, the computing device comprises a circuit configured to perform the following operations: determining a transition function based on the training set, the transition function being configured to determine a probability of perception category transition incurred from applying the decision; determining a reward function based on the training set, the reward function being configured to determine a reward obtained by applying the decision; and determining the trained decision model by training with a set of perception categories, a set of decisions, the transition function, and the reward function.

In some embodiments, the computing device comprises a circuit configured to perform the following operations: determining the set of perception categories and the set of decisions, the set of perception categories comprising a plurality of perception categories, and the set of decisions comprising a plurality of decisions.

In some embodiments, the computing device comprises a circuit configured to perform the following operations: determining the set of perception categories based on a target node in a causal model; and determining the set of decisions based on an actable node in the causal model.

In some embodiments, the computing device comprises a circuit configured to perform the following operations: determining a number of a plurality of decisions included in the set of decisions based on the actable node in the causal model.

In some embodiments, a target function refers to an expected value of a cumulative reward of one or more continuous stages during training with the set of perception categories, the set of decisions, the transition reward, and the reward function.

In some embodiments, the computing device comprises a circuit configured to perform the following operations: obtaining an updated perception category of the at least one target object after applying the target decision; constructing a data item based on the current perception category, the target decision, and the updated perception category of the at least one target object; and adding the data item into the training set for training the decision model so as to be used for updating the decision model.

In some embodiments, a computing device further comprises a circuit configured to perform the following operations: constructing a training set, the training set comprising a plurality of data items, each of the plurality of data items comprising: attribute information, a current perception category, a decision, a transitioned perception category for the attribute information from the current perception category after applying the decision, and corresponding reward information during transitioning from the current perception category to the transitioned perception category; and generating a decision model at least based on the training set.

In some embodiments, the computing device comprises a circuit configured to perform the following operations: determining a transition function based on the training set, the transition function is configured to determine a probability of perception category transition incurred from applying the decision; determining a reward function based on the training set, the reward function is configured to determine a reward obtained by applying the decision; and determining the trained decision model by training with a set of perception categories, a set of decisions, the transition function, and the reward function.

In some embodiments, the computing device comprises a circuit configured to perform the following operations: determining the set of perception categories and the set of decisions, the set of perception categories comprising a plurality of perception categories, and the set of decisions comprising a plurality of decisions.

In some embodiments, the computing device comprises a circuit configured to perform the following operations: determining the set of perception categories based on a target node in a causal model; and determining the set of decisions based on an actable node in the causal model.

In some embodiments, the computing device comprises a circuit configured to perform the following operations: determining a number of the plurality of decisions included in the set of decisions based on the actable node in the causal model.

In some embodiments, a target function is an expected value of a cumulative reward of one or more continuous stages during training with the set of perception categories, the set of decisions, the transition function, and the reward function.

FIG. 7 illustrates a schematic block diagram of an example device 700 adapted to implement embodiments of the present disclosure. For example, the computing device 110 as shown in FIG. 1 may be implemented by the device 700. As illustrated in the figure, the device 700 comprises a central processing unit (CPU) 701 that may perform various appropriate actions and processing based on computer program instructions stored in a read-only memory (ROM) 702 or computer program instructions loaded from a memory unit 708 to a random-access memory (RAM) 703. In the RAM 703, there may further store various programs and data needed for operations of the device 700. The CPU 701, ROM 702 and RAM 703 are connected to each other via a bus 704. An input/output (I/O) interface 705 is also connected to the bus 704.

Various components in the device 700 are connected to the I/O interface 705, including: an input unit 706 such as a keyboard, a mouse and the like; an output unit 707 such as various types of displays and loudspeakers, etc.; a memory unit 708 such as a magnetic disk, an optical disk, and etc.; and a communication unit 709 such as a network card, a modem, and a wireless communication transceiver, etc. The communication unit 709 allows the device 700 to exchange information/data with other devices via a computer network such as the Internet and/or various types of telecommunications networks. It is understood that the present disclosure may display, via the output unit 707, real-time dynamic change information of the customer satisfaction, key factor identification information of a group of customers or individual customers subjected to the satisfaction, optimized strategy information, and strategy implementation effect assessment information, etc.

The processing unit 701 may be implemented by one or more processing circuits. The processing unit 701 may be configured to perform various processes and processing described above, e.g., process 200 or process 400. For example, in some embodiments, the process 200 or process 400 may be implemented as a computer software program that is tangibly embodied on a machine readable medium, e.g., the memory unit 708. In some embodiments, part or all of the computer program may be loaded and/or mounted onto the device 700 via ROM 702 and/or communication unit 709. When the computer program is loaded to the RAM 703 and executed by the CPU 701, one or more steps of the process 200 or process 400 as described above may be executed.

The present disclosure may be implemented a system, a method and/or a computer program product. The computer program product may comprise a computer-readable storage medium on which computer-readable program instructions for executing various aspects of the present disclosure are loaded.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to optimal explain the principles of the embodiments, the practical application or technical improvement over technologies found in the marketplace, or to enable others of ordinary skill in the art to understand the embodiments disclosed herein.

I/We claim:

1. An information processing method, comprising:
obtaining input information from a user, the input information at least indicating at least one of: attribute information of at least one target object, or information of a current perception category of the at least one target object;
determining a target decision for the at least one target object based on the input information using a trained decision model; and
outputting the target decision.

2. The method according to claim 1, wherein determining the target decision for the at least one target object based on the input information using the trained decision model comprises:
determining the attribute information and the current perception category of the at least one target object based on the input information; and
determining the target decision corresponding to the current perception category of the at least one target object based on a decision solution derived from the trained decision model and corresponds to the attribute information of the at least one target object.

3. The method according to claim 2, wherein the decision solution at least indicates estimated values corresponding to respective decisions applied at the current perception category, and wherein an estimated value corresponding to the target decision is greater than each of estimated values corresponding to remaining decisions.

4. The method according to claim 2, wherein determining the target decision corresponding to the current perception category of the at least one target object based on the decision solution derived from the trained decision model and corresponds to the attribute information of the at least one target object comprises: determining a plurality of target decisions to be applied for a transition of the at least one target object from the current perception category to a plurality of target perception categories based on the decision solution corresponding to the attribute information of the at least one target object;
and wherein outputting the target decision comprises: outputting the plurality of target decisions for the at least one target object and the plurality of target perception categories corresponding to the plurality of target decisions.

5. The method according to claim 2, wherein the at least one target object corresponding to the input information comprises a plurality of target objects, the input information further comprises information of a number threshold, and wherein determining the target decision corresponding to the current perception category of the at least one target object based on the decision solution derived from the trained decision model and corresponds to the attribute information of the at least one target object comprises:
determining, based on decision solutions derived from the trained decision model and correspond to attribute information of respective target objects of the plurality of target objects, optimal decisions of the respective target objects and estimated values of the optimal decisions;
determining a part of the plurality of target objects based on the optimal decisions of the respective target objects and the estimated values of the optimal decisions, a number of the part of the of target objects not exceeding the number threshold; and
determining that the target decision for the part of target objects is an optimal decision for the part of target objects.

6. The method according to claim 2, wherein the at least one target object corresponding to the input information comprises a plurality of target objects, the input information further comprises information of a cost threshold, and wherein determining the target decision corresponding to the current perception category of the at least one target object based on the decision solution derived from the trained decision model and corresponds to the attribute information of the at least one target object comprises:
determining, based on decision solutions derived from the trained decision model and correspond to attribute information of respective target objects of the plurality of target objects, candidate decisions for the respective target objects; and
determining the target decision for the respective target objects from among the candidate decisions for the respective target objects, a total cost of applying respective target decisions to the respective target objects of the plurality of target objects meeting the cost threshold.

7. The method according to claim 1, wherein the at least one target object corresponding to the input information comprises a plurality of target objects, and wherein determining the target decision for the at least one target object based on the input information using the trained decision model comprises:
determining distribution information of the current perception category of the plurality of target objects, the distribution information indicating a proportion of a number of target objects belonging to respective current perception categories to a number of the plurality of target objects; and
determining the target decision for the plurality of target objects based on the distribution information and decision solutions derived from the trained decision model and correspond to attribute information of respective target objects of the plurality of target objects.

8. The method according to claim 1, wherein determining the target decision for the at least one target object based on the input information comprises: determining a plurality of target decisions corresponding to multiple stages for the at least one target object based on the input information;
and wherein outputting the target decision comprises: outputting the plurality of target decisions corresponding to the multiple stages.

9. The method according to claim 1, further comprising:
constructing a training set, the training set comprising a plurality of data items, each of the plurality of data items comprising: attribute information, a current perception category, a decision, a transitioned perception category for the attribute information from the current perception category after applying the decision, and corresponding reward information during transitioning from the current perception category to the transitioned perception category; and
generating the trained decision model at least based on the training set.

10. The method according to claim 9, wherein generating the trained decision model at least based on the training set comprises:
determining a transition function based on the training set, the transition function being configured to determine a probability of perception category transition incurred from applying the decision;
determining a reward function based on the training set, the reward function being configured to determine a reward obtained by applying the decision; and
determining the trained decision model by training with a set of perception categories, a set of decisions, the transition function, and the reward function.

11. The method according to claim 10, further comprising:
determining the set of perception categories and the set of decisions, the set of perception categories comprising a plurality of perception categories, and the set of decisions comprising a plurality of decisions.

12. The method according to claim 11, wherein determining the set of perception categories and the set of decisions comprises:
determining the set of perception categories based on a target node in a causal model; and
determining the set of decisions based on an actable node in the causal model.

13. The method according to claim 12, further comprising:
determining a number of a plurality of decisions included in the set of decisions based on the actable node in the causal model.

14. The method according to claim 10, wherein a target function is an expected value of a cumulative reward of one or more continuous stages during training with the set of perception categories, the set of decisions, the transition function, and the reward function.

15. The method according to claim 1, further comprising:
obtaining an updated perception category of the at least one target object after applying the target decision;
constructing a data item based on the current perception category, the target decision, and the updated perception category of the at least one target object; and
adding the data item into the training set for training the decision model so as to be used for updating the decision model.

16. A model training method, comprising:
constructing a training set, the training set comprising a plurality of data items, each of the plurality of data items comprising: attribute information, a current perception category, a decision, a transitioned perception category for the attribute information from the current perception category after applying the decision, and corresponding reward information during transitioning from the current perception category to the transitioned perception category; and
generating a decision model at least based on the training set.

17. The method according to claim 16, wherein generating the decision model at least based on the training set comprises:
determining a transition function based on the training set, the transition function is configured to determine a probability of perception category transition incurred from applying the decision;
determining a reward function based on the training set, the reward function is configured to determine a reward obtained by applying the decision; and
determining the trained decision model by training with a set of perception categories, a set of decisions, the transition function, and the reward function.

18. The method according to claim 17, further comprising:
determining the set of perception categories and the set of decisions, the set of perception categories comprising a plurality of perception categories, and the set of decisions comprising a plurality of decisions.

19. The method according to claim 18, wherein determining the set of perception categories and the set of decisions comprises:
determining the set of perception categories based on a target node in a causal model; and
determining the set of decisions based on an actable node in the causal model.

20. An electronic device, comprising:
at least one processing unit;
at least one memory being coupled to the at least one processing unit and configured to store instructions for being executed by the at least one processing unit, the instructions, when executed by the at least one processing unit, cause the device to:
obtain input information from a user, the input information at least indicating at least one of: attribute information of at least one target object, or information of a current perception category of the at least one target object;
determine a target decision for the at least one target object based on the input information using a trained decision model; and
output the target decision.
